(19) United States
(12) Patent Application Publication
(10) Pub. No.: US 2007/0275284 A1
(43) Pub. Date: Nov. 29, 2007

(54) LIQUID ELECTROLYTE FOR AN ELECTROCHEMICAL CELL

(76) Inventors: Donald R. Merritt, Brooklyn Center, MN (US); Craig L. Schmidt, Eagan, MN (US)

Correspondence Address: MEDTRONIC, INC., 710 MEDTRONIC PARKWAY NE, MINNEAPOLIS, MN, 55432-9924, US

(21) Appl. No.: 11/751,475

(22) Filed: May 21, 2007

Related U.S. Application Data
(63) Continuation-in-part of application No. 10/366,214, filed on Feb. 13, 2003, now abandoned.

(51) Int. Cl. H01M 8/08; H01M 4/36

(52) U.S. Cl. 429/29; 429/108

(57) ABSTRACT

A liquid electrolyte for use in an electrochemical cell having an alkali metal anode is provided. The liquid electrolyte comprises an additive formed of at least one selected from the group comprising: a tautomer; an alcohol having the formula R—OH, where R is one selected from the group comprising an unsaturated carbon chain having at least two carbon atoms, a saturated carbon chain having at least one carbon atom, and an aromatic carbon chain; a sugar; and an acid selected from the group comprising nitric acid, sulfuric acid and sulfuric acid partially substituted with an ion of said alkali metal material.

### FIELD OF THE INVENTION

The present invention generally relates to electrochemical cells, and more particularly relates to a liquid electrolyte solution for alkali metal electrochemical cells.

### BACKGROUND OF THE INVENTION

Implantable medical devices (IMDs) are well known for providing a variety of treatments to humans and animals. For example, implantable cardiac defibrillators are used to monitor the electrical activity of the heart of a patient, detect ventricular fibrillation, and in response to that detection, deliver appropriate shocks to restore a normal heart rhythm. Implantable neurostimulators have been used to stimulate the spinal cord and brain for a variety of treatments, including the treatment of chronic pain and the treatment of peripheral vascular disease. Implantable pacemakers generate and apply electric stimuli in the form of pulses to the tissue of a heart to control the timing of the contractions of the heart.

The above-described IMDs, and other similar devices, utilize an internal power source, or electrochemical cell, to provide the power required for a desired application. Depending upon the particular application, the power source may be required to provide energy of as little as 0.1 Joules or less, such as for pacemakers, to as much as 40 Joules or greater, as in the case of implantable defibrillators. In addition to providing sufficient energy, the power source preferably possesses low self-discharge to have a useful life and should be highly reliable.

A class of electrochemical cells used in IMDs comprises an anode, a cathode and a liquid electrolyte. It is well known that components in the liquid electrolyte can form a passivation film on the surface of the anode. For alkali metal anodes, such a film generally is unavoidable due to the low reduction potential of alkali metals and their high reactivity towards organic electrolytes. While the passivation film may protect the anode from self-discharge, typically it increases the internal resistance of the electrochemical cell, thus reducing the power capability of the electrochemical cell and shortening its lifespan.

Accordingly, it is desirable to provide a liquid electrolyte that permits formation of a conducting film on the anode, which film improves the electrical properties of the electrochemical cell and also protects the anode from self-discharge. In addition, it is desirable to provide an electrochemical cell that exhibits reduced internal resistance due to the reduction or elimination of an undesirable passivation film on the cell anode. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

According to an exemplary embodiment of the invention, there is provided a liquid electrolyte for use in an electrochemical cell having an alkali metal anode. The liquid electrolyte comprises an additive formed of at least one selected from the group comprising: a tautomer; an alcohol having the formula R—OH, where R is one selected from the group comprising an unsaturated carbon chain having at least two carbon atoms, a saturated carbon chain having at least one carbon atom, and an aromatic carbon chain; a sugar; and an acid selected from the group comprising nitric acid, sulfuric acid and sulfuric acid partially substituted with an ion of said alkali metal material.

According to another exemplary embodiment of the invention, there is provided an electrochemical cell comprising an anode formed of an alkali metal material, a cathode, and a liquid electrolyte operatively associated with the anode and the cathode. The liquid electrolyte comprises an additive comprising at least one selected from the group comprising: a tautomer; an alcohol having the formula R—OH, where R is one selected from the group comprising an unsaturated carbon chain having at least two carbon atoms, a saturated carbon chain having at least one carbon atom, and an aromatic carbon chain; a sugar; and an acid selected from the group comprising nitric acid, sulfuric acid and sulfuric acid partially substituted with an ion of said alkali metal material.

According to a further exemplary embodiment of the invention, there is provided an implantable medical device comprising an electrochemical cell. The electrochemical cell comprises an anode formed of an alkali metal material, a cathode and a liquid electrolyte operatively associated with the anode and the cathode. The liquid electrolyte comprises an additive comprising at least one selected from the group comprising: a tautomer; an alcohol having the formula R—OH, where R is one selected from the group comprising an unsaturated carbon chain having at least two carbon atoms, a saturated carbon chain having at least one carbon atom, and an aromatic carbon chain; a sugar; and an acid selected from the group comprising nitric acid, sulfuric acid and sulfuric acid partially substituted with an ion of said alkali metal material.

### BRIEF DESCRIPTION OF THE DRAWINGS

The present invention will hereinafter be described in conjunction with the following drawing figures, wherein like numerals denote like elements, and

FIG. 1 is a simplified schematic view of one embodiment of an implantable medical device (IMD) incorporating an electrochemical cell;

FIG. 2 is an exploded perspective view of various components, including an electrochemical cell, disposed within the housing of one embodiment of an IMD;

FIG. 3 is a perspective view of an electrochemical cell, with a portion cutaway; and

FIG. 4 is an enlarged view of a portion of the cell of FIG. 3 designated by the line 4.

### DETAILED DESCRIPTION OF THE INVENTION

The following description is exemplary in nature and is not intended to limit the scope, applicability, or configuration of the invention in any way. Rather the following description provides a convenient illustration for implementing exemplary embodiments of the invention. Various changes to the described embodiments may be made in the function and arrangements of the elements described herein without departing from the scope of the invention. Furthermore, there is no intention to be bound by any theory presented in the preceding background of the invention or the following detailed description of the invention.

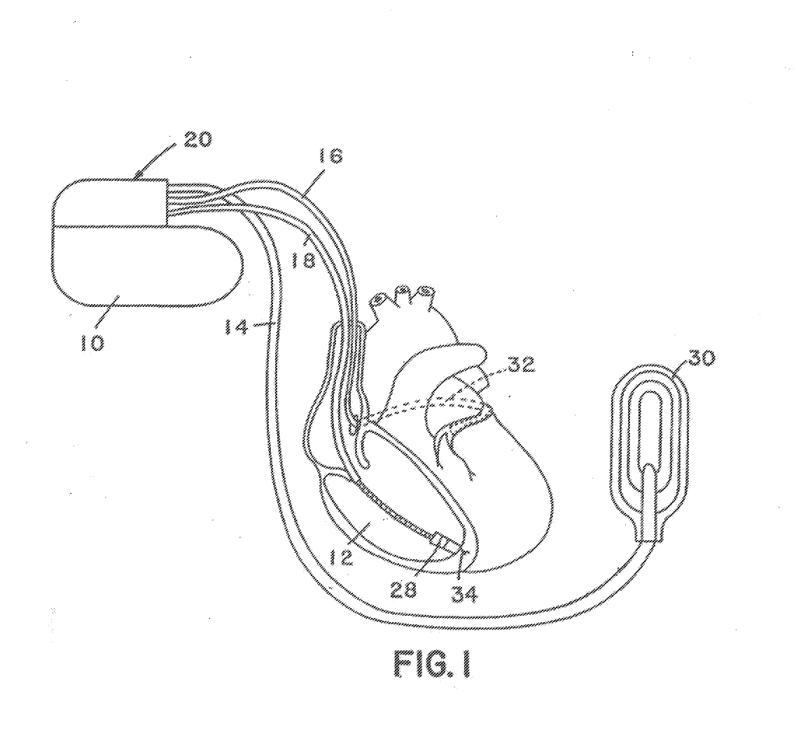

FIG. 1 is a simplified schematic view of an example of an implantable medical device (“IMD”) 10, in accordance with an exemplary embodiment of the present invention. The IMD 10 is shown in FIG. 1 as a pacemaker/cardioverter/defibrillator (PCD) with a relationship to the human heart. However, IMD 10 may assume a wide variety of forms. For example, IMD 10 may be an implantable cardiac defibrillator (ICD as is known in the art). Alternatively, or in addition, IMD 10 may be an implantable cardiac pacemaker, such as that disclosed in U.S. Pat. No. 5,158,078 to Bennett et al.; U.S. Pat. No. 5,312,453 to Shelton et al.; or U.S. Pat. No. 5,144,949 to Olson, all hereby incorporated by reference, each in its entirety. Even further, IMD 10 may be an implantable neurostimulator, such as that described, for example, in U.S. Pat. No. 5,342,409 to Mullet; or an implantable drug pump; a cardiomyostimulator; a biosensor; and the like.

IMD 10 includes associated electrical leads 14, 16 and 18, although it will be appreciated that IMD 10 may include any number of leads suitable for a particular application. Leads 14, 16 and 18 are coupled to IMD 10 by means of a multi-port connector block 20, which contains separate ports for each of the three leads 14, 16, and 18. Lead 14 is coupled to a subcutaneous electrode 30, which is intended to be mounted subcutaneously in the region of the left chest. Alternatively, an active “can” may be employed. Lead 16 is a coronary sinus lead employing an elongated coil electrode that is located in the coronary sinus and great vein region of a heart 12. The location of the electrode is illustrated in broken line format at 32, and extends around heart 12 from a point within the opening of the coronary sinus to a point in the vicinity of the left atrial appendage.

Lead 18 is provided with elongated electrode coil 28, which is located in the right ventricle of heart 12. Lead 18 also includes a helical stimulation electrode 34, which takes the form of an advanceable helical coil that is screwed into the myocardial tissue of the right ventricle. Lead 18 may also include one or more additional electrodes for near and far field electrogram sensing.

In the system illustrated, cardiac pacing pulses are delivered between the helical electrode 24 and the elongated electrode 28. The electrodes 28 and 34 are also employed to sense electrical signals indicative of ventricular contractions. As illustrated, it is anticipated that the right ventricular electrode 28 will serve as the common electrode during sequential and simultaneous pulse multiple electrode defibrillation regimens. For example, during a simultaneous pulse defibrillation regimen, pulses would simultaneously be delivered between electrode 28 and electrode 30, and between electrode 28 and electrode 32. During sequential pulse defibrillation, it is envisioned that pulses would be delivered sequentially between subcutaneous electrode 30 and electrode 28, and between coronary sinus electrode 32 and right ventricular electrode 28. Single pulse, two electrode defibrillation pulse regimens may also be provided, typically between electrode 28 and coronary sinus electrode 32. Alternatively, single pulses may be delivered between electrodes 28 and 30. The particular interconnection of the electrodes to the IMD 10 will depend somewhat on which specific single electrode pair defibrillation pulse regimen is believed more likely to be employed.

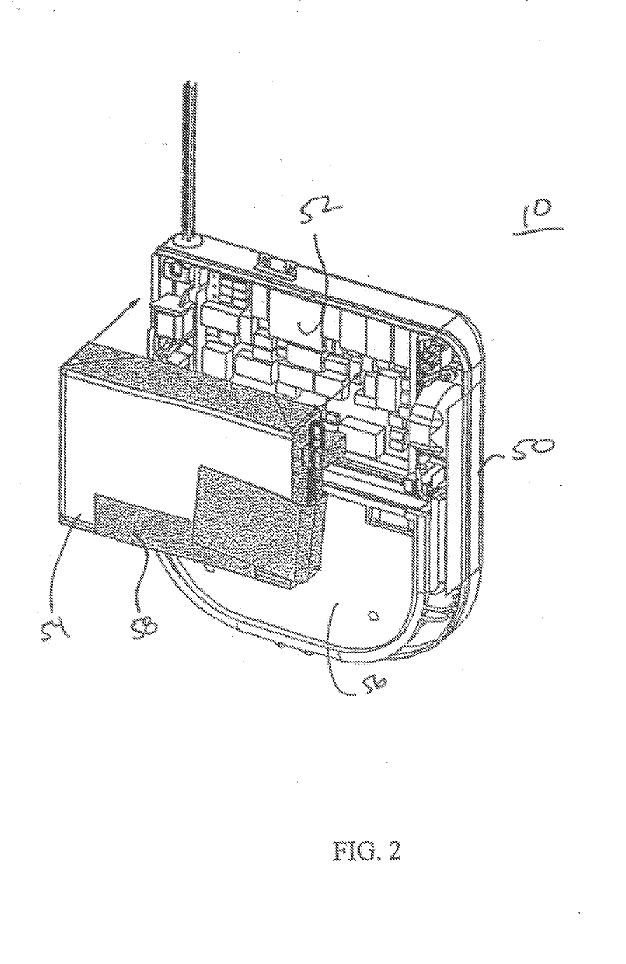

As previously described, IMD 10 may assume a wide variety of forms as are known in the art. One example of various components of an IMD 10 is shown in FIG. 2. IMD 10 includes a case 50 (the right-hand side of which is shown in FIG. 2), an electronics module 52, a battery or electrochemical cell 54, and capacitor(s) 56. Each of the components of the IMD 10 is preferably configured for the particular end-use application. Thus, the electronics module 52 is configured to perform one or more sensing and/or stimulation processes. Electrochemical cell 54 includes an insulator 58 disposed therearound. Electrochemical cell 54 provides the electrical energy to charge and re-charge the capacitor(s) 56, and also powers the electronics module 52.

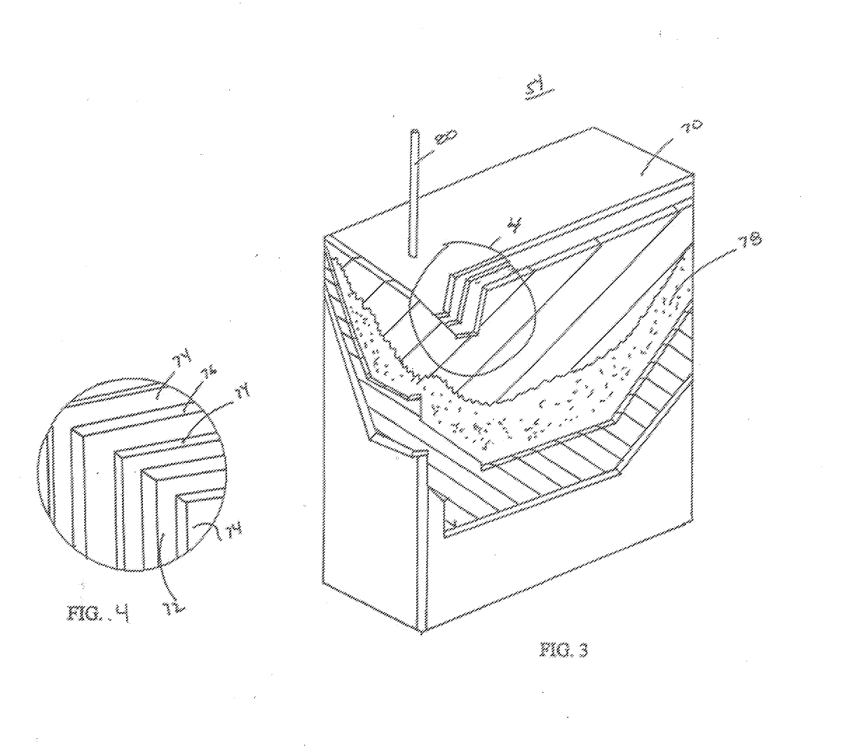

Electrochemical cell 54 may assume a wide variety of forms as is known in the art. In accordance with an exemplary embodiment of the present invention, electrochemical cell 54 comprises an anode, a cathode, and a liquid electrolyte operatively associated with the anode and the cathode. The electrolyte serves as a medium for migration of ions between the anode and the cathode during the electrochemical reactions of the cell. One example of electrochemical cell 54 is shown in FIGS. 3 and 4. Electrochemical cell 54 includes a case 70, an anode 72, separators 74, a cathode 76, a liquid electrolyte 78 and a feedthrough terminal 80. Case 70 contains the various components. Cathode 76 therein is wound in a plurality of turns, with anode 72 interposed between the turns of the cathode winding. Separator 74 separates anode 72 from cathode 76 windings. Case 70 also contains the liquid electrolyte 78, described in more detail below. As a result, an electrical connection is provided to anode 72 and an electrical connection is provided to cathode 76.

Electrochemical cell 54 may be a high-capacity, high-rate, spirally-wound battery of the type disclosed, for example, in U.S. Pat. No. 5,439,760 to Howard et al. for “High Reliability Electrochemical Cell and Electrode Assembly Therefor,” and U.S. Pat. No. 5,434,017 to Berkowitz et al. for “Isolated Connection for An Electrochemical Cell,” both which are hereby incorporated by reference in their entireties.

Electrochemical cell 54 may also be a battery having spirally-wound, stacked plate, or serpentine electrodes of the type disclosed, for example, in U.S. Pat. Nos. 5,312,458 and 5,250,373 to Muffuletto et al. for “Internal Electrode and Assembly Method for Electrochemical Cells;” U.S. Pat. No. 5,549,717 to Takeuchi et al. for “Method of Making Prismatic Cell;” U.S. Pat. No. 4,964,877 to Kiester et al. for “Non-Aqueous Lithium Battery;” U.S. Pat. No. 5,147,737 to Post et al. for “Electrochemical Cell With Improved Efficiency Serpentine Electrode;” and U.S. Pat. No. 5,468,569 to Pyszczek et al. for “Use of Standard Uniform Electrode Components in Cells of Either High or Low Surface Area Design,” the disclosures of which are hereby incorporated by reference herein in their respective entireties. Alternatively, electrochemical cell 54 can include a single cathode electrode as described, for example, in U.S. Pat. No. 5,716,729 to Sunderland et al. for “Electrochemical Cell,” which is hereby incorporated by reference in its entirety.

The anode of electrochemical cell 54, such as anode 72, is formed of a material selected from Group IA, IIA or IIIB of the Periodic Table of Elements, including lithium, sodium, potassium, etc. and their alloys and intermetallic compounds including, for example, Li—Si, Li—B and Li—Si—B alloys and intermetallic compounds. Preferably, the anode comprises an alkali metal and more preferably comprises lithium, either in metallic form or ion form for re-chargeable applications.

Materials for the cathode of electrochemical cell 54, such as cathode 76, are most preferably solid and comprise as active components thereof metal oxides such as vanadium oxide, silver vanadium oxide (SVO) or manganese dioxide. Alternatively, the cathode may also comprise carbon monofluoride and hybrids thereof (e.g., CFₓ+MnO₂) or any other active electrolytic components in combination. Notably, a “solid” cathode is in the reference to pressed porous solid cathodes, as known in the art. Such cathodes are typically made by mixing one or more active components with poly(tetrafluorethylene) as a binder and carbon as a conductivity enhancer, and pressing those components to form a porous solid structure. The cathode may also be formed of “combination silver vanadium oxide” or “CSVO” as disclosed in U.S. Pat. Nos. 5,221,453, 5,439,760, and 5,306,581. It is to be understood, however, that any type of suitable SVO may be employed in cathodes in electrochemical cells including substitute SVO as disclosed by Takeuchi et al. in U.S. Pat. No. 5,472,810 and disclosed by Leising et al. in U.S. Pat. No. 5,695,892, SVO made by the decomposition method as disclosed by Liang et al. in U.S. Pat. Nos. 4,310,609 and 4,391,729, amorphous SVO as disclosed by Takeuchi et al. in U.S. Pat. No. 5,498,494, SVO prepared by the sol-gel method as disclosed by Takeuchi et al. in U.S. Pat. No. 5,558,680, and SVO prepared by the hydrothermal process. Other suitable methods for forming cathodes of SVO are disclosed in U.S. Pat. Nos. 6,130,005, 6,093,506, 5,955,218 and 5,895,733 by Crespi et al. All of the above-identified patents are herein incorporated by reference in their entireties.

It is to be understood that electrochemical systems other than those set forth explicitly above may also be employed in conjunction with the present invention, including, but not limited to, cathode/anode systems such as: silver oxide/lithium; manganese oxide/lithium; V₂O₅/lithium; copper silver vanadium oxide/lithium; copper oxide/lithium; lead oxide/lithium; carbon monofluoride/lithium; chromium oxide/lithium; bismuth-containing oxides/lithium; copper sulfate/lithium; mixtures of various cathode materials listed above such as a mixture of silver vanadium oxide and carbon monofluoride; and lithium ion rechargeable batteries, to name but a few.

The liquid electrolyte of electrochemical cell 54, such as electrolyte 78, may include an organic solvent in combination with an ionizing solution. The organic solvent can be, for example, diethyl carbonate, dimethylcarbonate, butylene carbonate, 3-methyl-2-oxazolidone, sulfolane, tetrahydrofuran, methyl-substituted tetrahydrofuran, 1,3-dioxolane, propylene carbonate (PC), ethylene carbonate, gamma-butyrolactone, ethylene glycol sulfite, dimethylsulfite, dimethyl sulfoxide, dimethoxyethane, dimethyl isoxazole, dioxane, ethyl methyl carbonate, methyl formate, diglyme, or the like, or mixtures thereof. The ionizing solute can be a simple or soluble salt or mixtures thereof, for example, LiBF₄, LiAsF₆, LiPF₆, LiClO₄, LiN(SOCF₃)₂, or LiC(SOCF₃)₃, which will produce an ionically conductive solution when dissolved in one or more solvents.

In accordance with an exemplary embodiment of the present invention, the liquid electrolyte of electrochemical cell 54 comprises an additive that readily forms an anion. The anion state of the additive forms a salt with the alkali metal anode, thus forming an ionically conductive film on the anode. In the absence of the additive, the electrochemical cell would experience greater internal resistance, both during application-rate discharge and open-circuit storage. The additive comprises those materials that form an anion by liberating a proton. Typically, the additive is present in the liquid electrolyte in the range of about 0.001 to about 0.4 M.

In accordance with one exemplary embodiment of the present invention, the additive comprises tautomers, that is, those materials that liberate a proton through tautomerization. Examples of such materials include, but are not limited to, nitromethane, urea, ketones, and the following:

carbonyls, including carboxylic acids, carboxylic diacids, and salts of carboxylic acids and diacids, such as those having the formulas:

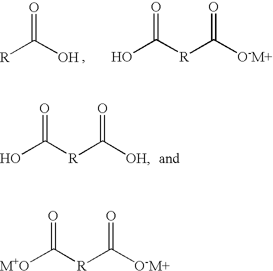

where R is any carbon-containing moiety,

nitriles, such as those having the formulas: N≡C—CH, HN—C═C,

imines, such as those having the formula N═C—CH, enamines, such as those having the formula HN—C═C,

nitrosos functional groups, such as those having the formula: O═N—CH,

oxime functional groups, such as those having the formula: HO—N═C,

nitro functional groups, such as those having the formula:

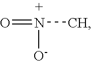

aci-nitro functional groups, such as those having the formula:

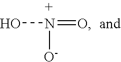

keto-alcohols and hemiketals, keto-acids and lactols.

In accordance with another exemplary embodiment of the present invention, the additive may comprise an alcohol having the formula R—O—H, where R is an unsaturated carbon chain having at least two carbon atoms, or a saturated carbon chain having at least one carbon atom, or an aromatic carbon chain. In addition, the alcohol may comprise a polyol having the formula H—O—R—O—H. Examples of suitable alcohols for use in the liquid electrolyte of the present invention include, but are not limited to, resorcinol, phenol, xylitol, methanol, ethanol, and isopropyl alcohol.

In accordance with a further exemplary embodiment of the present invention, the additive may comprise a sugar, such as, for example, glucose, sucrose, fructose, and the like.

In accordance with yet another exemplary embodiment of the present invention, the additive may comprise nitric acid (HNO₃), sulfuric acid (H₂SO₄), or sulfuric acid partially substituted with an ion of the alkali metal material. For example, for lithium anodes, the additive may comprise LiHSO₄.

The liquid electrolyte of the present invention may be produced using methods as are well known, with the above-described additives added to the organic solvent and ionizing solute, in any suitable order, using methods such as stirring, agitation and the like. The liquid electrolyte with the desired additive may also be subjected to a suitable temperature treatment to further facilitate combination of the components.

In another embodiment, the additive includes tetramethylammonium hydrogen phthalate which includes the chemical structure
Unregistered PLT

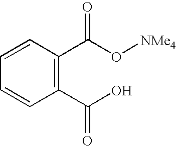

Thus, there has been provided, in accordance with the invention, a liquid electrolyte for use in an electrochemical cell. The liquid electrolyte comprises an additive that, by liberating a proton, is capable of forming an ionically conducting film on the anode of the electrochemical cell. Although various embodiments of the invention have been described and illustrated with reference to specific embodiments thereof, it is not intended that the invention be limited to such illustrative embodiments. For example, while implantable medical device IMD 10 is illustrated in FIG. 1 as associated with the heart, IMD 10 can be used for the monitoring of or treatment to any part of a human or animal body and, hence, may have any suitable configuration for the desired application. Further, it will be appreciated that the electrolyte solution of the present invention may be used for alkali metal primary (non-rechargeable) or alkali metal or alkali ion secondary (rechargeable) electrochemical cells. Those of skill in the art will recognize that many variations and modifications of such embodiments are possible without departing from the spirit of the invention. Accordingly, it is intended to encompass within the invention all such modifications and variations as fall within the scope of the appended claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A liquid electrolyte for use in an electrochemical cell having an alkali metal anode, the liquid electrolyte comprising an additive formed of at least one selected from the group comprising:
a tautomer;
an alcohol having the formula R—OH, where R is one selected from the group comprising an unsaturated carbon chain having at least two carbon atoms, a saturated carbon chain having at least one carbon atom, tetramethylammonium hydrogen phthalate, and an aromatic carbon chain;
a sugar; and
an acid selected from the group comprising nitric acid, sulfuric acid and sulfuric acid partially substituted with an ion of said alkali metal material.

2. The liquid electrolyte of claim 1, said alkali metal anode comprising one of lithium, sodium, and potassium.

3. The liquid electrolyte of claim 1, further comprising an organic solvent.

4. The liquid electrolyte of claim 3, said organic solvent comprising at least one selected from the group comprising diethyl carbonate, dimethylcarbonate, butylene carbonate, 3-methyl-2-oxazolidone, sulfolane, tetrahydrofuran, methyl-substituted tetrahydrofuran, 1,3-dioxolane, propylene carbonate (PC), ethylene carbonate, gamma-butyrolactone, ethylene glycol sulfite, dimethylsulfite, dimethyl sulfoxide, dimethoxyethane, dimethyl isoxazole, dioxane, ethyl methyl carbonate, diglyme, and methyl formate.

5. The liquid electrolyte of claim 1, further comprising an alkali metal salt.

6. The liquid electrolyte of claim 1, wherein said tautomer comprise one selected from the group comprising nitromethane, urea, ketones, carbonyls, imines, enamines, nitrosos functional groups, oxime functional groups, nitros functional groups, aci-nitro functional groups, nitriles, keto-alcohols, hemiketals, keto-acids, and lactols.

7. The liquid electrolyte of claim 6, wherein said tautomer is a carbonyl selected from the group comprising carboxylic acid, carboxylic diacid, and salts thereof.

8. The liquid electrolyte of claim 1, wherein said alcohol comprises a polyol.

9. The liquid electrolyte of claim 1, wherein said sugar comprises one selected from the group comprising glucose, sucrose, and fructose.

10. The liquid electrolyte of claim 1, wherein the additive is present in the liquid electrolyte in the range of about 0.001 to about 0.4 M.

11. An electrochemical cell comprising:
an anode comprising an alkali metal material;
a cathode;
a liquid electrolyte operatively associated with the anode and the cathode, said electrolyte comprising an additive comprising at least one selected from the group comprising:
a tautomer;
an alcohol having the formula R—OH, where R is one selected from the group comprising an unsaturated carbon chain having at least two carbon atoms, a saturated carbon chain having at least one carbon atom, and an aromatic carbon chain;
a sugar; and
an acid selected from the group comprising nitric acid, sulfuric acid and sulfuric acid partially substituted with an ion of said alkali metal material.

12. The electrochemical cell of claim 11, said anode comprising one of lithium, sodium, and potassium.

13. The electrochemical cell of claim 11, said cathode comprising at least one selected from the group comprising silver oxides, manganese oxides, vanadium oxides, copper silver vanadium oxides, copper oxides, lead oxides, carbon monofluoride, chromium oxides, bismuth-containing oxides, and copper sulfate.

14. The electrochemical cell of claim 11, wherein said electrochemical cell is a non-rechargeable cell.

15. The electrochemical cell of claim 11, wherein said electrochemical cell is a rechargeable cell.

16. The electrochemical cell of claim 11, said liquid electrolyte further comprising an organic solvent.

17. The electrochemical cell of claim 16, said organic solvent comprising at least one selected from the group comprising diethyl carbonate, dimethylcarbonate, butylene carbonate, 3-methyl-2-oxazolidone, sulfolane, tetrahydrofuran, methyl-substituted tetrahydrofuran, 1,3-dioxolane, propylene carbonate (PC), ethylene carbonate, gamma-butyrolactone, ethylene glycol sulfite, dimethylsulfite, dimethyl sulfoxide, dimethoxyethane, dimethyl isoxazole, dioxane, ethyl methyl carbonate, diglyme, and methyl formate.

18. The electrochemical cell of claim 11, said liquid electrolyte further comprising an alkali metal salt.

19. The electrochemical cell of claim 11, wherein said tautomer comprise one selected from the group comprising nitromethane, urea, ketones, carbonyls, imines, enamines, nitrosos functional groups, oxime functional groups, nitros functional groups, aci-nitro functional groups, nitriles, keto-alcohols, hemiketals, keto-acids, and lactols.

20. The electrochemical cell of claim 19, wherein said tautomer is a carbonyl selected from the group comprising carboxylic acid, carboxylic diacid, and salts thereof.

21. The electrochemical cell of claim 11, wherein said alcohol comprises a polyol.

22. The electrochemical cell of claim 11, wherein said sugar comprises one selected from the group comprising glucose, sucrose, and fructose.

23. The electrochemical cell of claim 11, wherein the additive is present in the liquid electrolyte in the range of about 0.001 to about 0.4 M.

24. An implantable medical device comprising an electrochemical cell, said electrochemical cell comprising an anode formed of an alkali metal material, a cathode, and a liquid electrolyte operatively associated with the anode and the cathode, said liquid electrolyte comprising an additive comprising at least one selected from the group comprising:
a tautomer;
an alcohol having the formula R—OH, where R is one selected from the group comprising an unsaturated carbon chain having at least two carbon atoms, a saturated carbon chain having at least one carbon atom, and an aromatic carbon chain;
a sugar; and
an acid selected from the group comprising nitric acid, sulfuric acid and sulfuric acid partially substituted with an ion of said alkali metal material.

25. The implantable medical device of claim 24, said anode comprising one of lithium, sodium, and potassium.

26. The implantable medical device of claim 24, said cathode comprising at least one selected from the group comprising silver oxides, manganese oxides, vanadium oxides, copper silver vanadium oxides, copper oxides, lead oxides, carbon monofluoride, chromium oxides, bismuth-containing oxides, and copper sulfate.

27. The implantable medical device of claim 24, wherein said electrochemical cell is a non-rechargeable cell.

28. The implantable medical device of claim 24, wherein said electrochemical cell is a rechargeable cell.

29. The implantable medical device of claim 24, said liquid electrolyte further comprising an organic solvent.

30. The implantable medical device of claim 29, said organic solvent comprising at least one selected from the group comprising diethyl carbonate, dimethylcarbonate, butylene carbonate, 3-methyl-2-oxazolidone, sulfolane, tetrahydrofuran, methyl-substituted tetrahydrofuran, 1,3-dioxolane, propylene carbonate (PC), ethylene carbonate, gamma-butyrolactone, ethylene glycol sulfite, dimethylsulfite, dimethyl sulfoxide, dimethoxyethane, dimethyl isoxazole, dioxane, ethyl methyl carbonate, diglyme, and methyl formate.

31. The implantable medical device of claim 24, said liquid electrolyte further comprising an alkali metal salt.

32. The implantable medical device of claim 24, wherein said tautomer comprise one selected from the group comprising nitromethane, urea, ketones, carbonyls, imines, enamines, nitrosos functional groups, oxime functional groups, nitros functional groups, aci-nitro functional groups, nitriles, keto-alcohols, hemiketals, keto-acids, and lactols.

33. The implantable medical device of claim 32, wherein said tautomer is a carbonyl selected from the group comprising carboxylic acid, carboxylic diacid, and salts thereof.

34. The implantable medical device of claim 24, wherein said alcohol comprises a polyol.

35. The implantable medical device of claim 24, wherein said sugar comprises one selected from the group comprising glucose, sucrose, and fructose.

36. The implantable medical device of claim 24, wherein the additive is present in the liquid electrolyte in the range of about 0.001 to about 0.4 M.
